(19) United States
(12) Patent Application Publication
(10) Pub. No.: US 2020/0143400 A1
(43) Pub. Date: May 7, 2020

(54) VERIFICATION METHOD FOR DIVISION OF ADMINISTRATIVE REGION, SERVER AND STORAGE MEDIUM

(71) Applicant: Ping An Technology (Shenzhen) Co., Ltd., Shenzhen (CN)

(72) Inventor: Ying Chen, Shenzhen (CN)

(21) Appl. No.: 16/095,927

(22) PCT Filed: Oct. 27, 2017
(86) PCT No.: PCT/CN2017/108028

§ 371 Date: Oct. 23, 2018

(30) Foreign Application Priority Data
Jul. 28, 2017 (CN) 201710629604.6

(51) Int. Cl. G06Q 30/02; G06Q 40/08; G06Q 10/06; G06T 11/20

(52) U.S. Cl. CPC G06Q 30/0205; G06T 11/203; G06Q 10/0631; G06Q 40/08

(57) ABSTRACT

A verification method for division of an administrative region includes steps of: acquiring a region name of an administrative region; loading an electronic map corresponding to the administrative region according to the region name, the administrative region being divided into a plurality of sub-regions in the electronic map; acquiring an insurance policy quantity corresponding to the region name, and a road section quantity corresponding to the region name; performing a verification on the plurality of sub-regions of the administrative region by making use of the insurance policy quantity and the road section quantity; and recording the plurality of sub-regions of the administrative region as reasonable sub-regions if the verification is passed.

### CROSS-REFERENCE TO RELATED APPLICATIONS

This application claims priority to Chinese Patent Application No. 2017106296046, entitled “Verification Method and Device for Division of Administrative Region, Server and Storage Medium” filed on Jul. 28, 2017, the contents of which are expressly incorporated herein by reference in their entirety.

### TECHNICAL FIELD

The present disclosure relates to computer technology, and more particularly, to a verification method and device for division of an administrative region, a server, and a storage medium.

### BACKGROUND

Insurance as a safeguard mechanism has been integrated into people's lives. The type of insurance is also various. Different types of insurance can provide different guarantees for clients. For different types of insurance, insurance companies can arrange for business personnel to go to the client's location to provide clients with different services. In order to make it easier for business personnel to work in a more concentrated area, insurance companies can arrange business personnel by taking into consideration of the administrative region. The insurance company divides the administrative region through the back-end server, and then can arrange different business personnel by making use of the division. Before arranging business personnel by making use of the division, how to effectively verify the division of an administrative region has become a technical problem that needs to be solved.

### SUMMARY

According to various embodiments of the present invention, a verification method and device for division of an administrative region, a server, and a storage medium are provided.

A verification method for division of an administrative region includes:

acquiring a region name of an administrative region;

loading an electronic map corresponding to the administrative region according to the region name, the administrative region being divided into a plurality of sub-regions in the electronic map;

acquiring an insurance policy quantity corresponding to the region name, and a road section quantity corresponding to the region name;

performing a verification on the plurality of sub-regions of the administrative region by making use of the insurance policy quantity and the road section quantity; and

recording the plurality of sub-regions of the administrative region as reasonable sub-regions if the verification is passed.

A device for division of an administrative region includes:

a loading module, configured to acquire a region name of an administrative region; to load an electronic map corresponding to the administrative region according to the region name, the administrative region being divided into a plurality of sub-regions in the electronic map;

a verification module, configured to acquire an insurance policy quantity corresponding to the region name, and a road section quantity corresponding to the region name; to perform a verification on the plurality of sub-regions of the administrative region by making use of the insurance policy quantity and the road section quantity; and

a recording module, configured to record the plurality of sub-regions of the administrative region as reasonable sub-regions if the verification is passed.

A server includes a memory and one or more processors, the memory having computer-readable instructions stored thereon, following steps are implemented when the computer-readable instructions are executed by the one or more processors:

acquiring a region name of an administrative region;

loading an electronic map corresponding to the administrative region according to the region name, the administrative region being divided into a plurality of sub-regions in the electronic map;

acquiring an insurance policy quantity corresponding to the region name, and a road section quantity corresponding to the region name;

performing a verification on the plurality of sub-regions of the administrative region by making use of the insurance policy quantity and the road section quantity; and

recording the plurality of sub-regions of the administrative region as reasonable sub-regions if the verification is passed.

One or more non-transitory computer-readable storage medium include computer-readable instructions, following steps are implemented when the computer-readable instructions are executed by the one or more processors:

acquiring a region name of an administrative region;

loading an electronic map corresponding to the administrative region according to the region name, the administrative region being divided into a plurality of sub-regions in the electronic map;

acquiring an insurance policy quantity corresponding to the region name, and a road section quantity corresponding to the region name;

performing a verification on the plurality of sub-regions of the administrative region by making use of the insurance policy quantity and the road section quantity; and

recording the plurality of sub-regions of the administrative region as reasonable sub-regions if the verification is passed.

The details of one or more embodiments of the present invention are set forth in the accompanying drawings and the description below. Other features, objectives, and advantages of the present disclosure will become apparent from the description, the drawings, and the claims.

### BRIEF DESCRIPTION OF THE DRAWINGS

To illustrate the technical solutions in the embodiments of the present invention or in the prior art more clearly, the accompanying drawings for describing the embodiments or the prior art are introduced briefly as below. Apparently, the accompanying drawings in the following description are only some embodiments of the present invention, and persons of ordinary skill in the art can derive other drawings from the accompanying drawings without creative efforts.

FIG. 1 is a schematic diagram illustrating a hardware environment adapted for a verification method for division of an administrative region according to one of the embodiments;

FIG. 2 is a flowchart illustrating a verification method for division of an administrative region according to one of the embodiments;

FIG. 3 is a block diagram of a verification device for division of an administrative region according to one of the embodiments;

FIG. 4 is a block diagram of a server according to one of the embodiments.

### DETAILED DESCRIPTION OF THE EMBODIMENTS

In order to make the objectives, technical solutions and advantages of the present disclosure more clear, the present application will be further described in detail below with reference to the accompanying drawings and embodiments. It will be understood that the particular embodiments described herein are merely illustrative of the present disclosure and are not intended to limit the present disclosure.

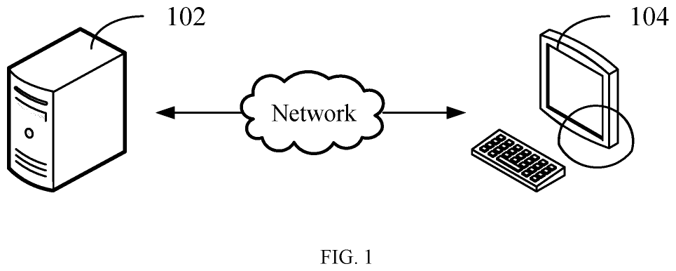

In one embodiment of the present invention, a verification method for division of an administrative region is provided, which can be implemented in the hardware environment shown in FIG. 1. A server 102 communicates with a terminal 102 over a network. The server 102 can acquire a region name of an administrative region, and load an electronic map corresponding to the administrative region. The server 102 stores a hierarchical relationship of each administrative region in advance. The server 102 can divide the administrative region into sub-regions of a plurality of hierarchies in the electronic map according to the hierarchical relationship of the administrative region. When the server 102 performs a verification on the sub-regions of each independent administrative region, the server 102 can verify the division result of the sub-regions of the road section hierarchy, by taking into consideration of the insurance policy quantity and the road section quantity in the administrative region. A database is deployed on the server 102 and insurance policy data is stored in the database. The server 102 can obtain the insurance policy quantity corresponding to the region name by performing statistics through the insurance policy identification in the insurance policy data. The database also stores names of all the road sections corresponding to a plurality of administrative regions. The server 102 can acquire a road section name in the administrative region according to the region name, and count the number of road sections in the administrative region according to the road section name. The server 102 performs a verification on the plurality of the sub-regions of the administrative region by making use of the insurance policy quantity corresponding to the region name and the road section quantity. The server 102 can record the sub-regions that have passed the verification as reasonable sub-regions, that is, as sub-regions suitable for arranging business personnel to provide services. When a manager of an insurance company assigns a business personnel to visit the client's location to provide services for a client, the manager can query the reasonable sub-regions through the terminal 104, and generate a corresponding service task by making use of the business personnel's identification and reasonable sub-regions. Thereby the result of division of the administrative region is utilized for arranging different business personnel to serve in different regions.

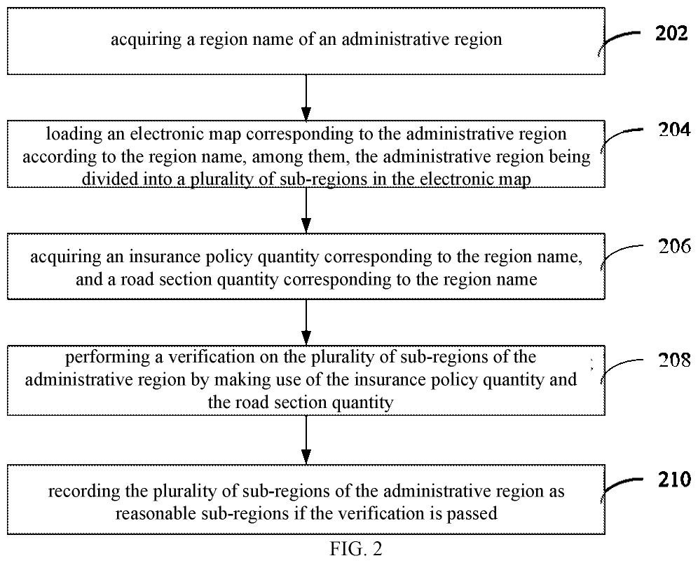

In one embodiment, as shown in FIG. 2, a verification method for division of an administrative region is provided. It should be understood that, although the various steps in the flowchart of FIG. 2 are sequentially displayed as indicated by the arrows, these steps are not necessarily in the order indicated by the arrows. Except as expressly stated in this document, the execution of these steps is not strictly limited by the order, and the steps may be performed in other orders. Moreover, at least some of the steps in FIG. 2 may include a plurality of sub-steps or phases. These sub-steps or phases do not necessarily have to be completed at the same time, but may be performed at different time instants, and the steps do not necessarily have to be executed in sequence, but may be performed in turn or alternately with at least a portion of other steps or sub-steps or phases of other steps. The method is described by taking an example when it is applied to a server, and the method includes the following steps:

Step S202, acquiring a region name of an administrative region.

Step S204, loading an electronic map corresponding to the administrative region according to the region name, the administrative region being divided into a plurality of sub-regions in the electronic map.

The server acquires the region name of the administrative region, the administrative region includes a city, district, county, and town, etc. For example, Futian District of Shenzhen City. The region name acquired by the server may be uploaded by the administrator through the terminal, or may be acquired through a configuration file stored in the database. The server loads the electronic map corresponding to the administrative region according to the region name. The electronic map may be an electronic map provided by a third party, for example, Baidu map or the like. The server can divide the administrative region into sub-regions of different hierarchies in the electronic map according to the hierarchical relationship of the administrative region. It is convenient for insurance companies to arrange business personnel for sub-regions of different hierarchies by making use of the hierarchical relationship of the administrative region.

Specifically, the hierarchical relationship of each administrative region is pre-stored on the server, and the hierarchical relationship includes a parent hierarchy and a child hierarchy. For the child hierarchy, besides being a child hierarchy of the upper hierarchy (for example, the parent hierarchy), it may also be the parent hierarchy of the next hierarchy. A child hierarchy that does not have a subordinate hierarchy can also be called a leaf hierarchy. The hierarchies of an administrative region include the hierarchy of administrative region, the hierarchy of road section, and the hierarchy of interest points, wherein, the interest points refer to buildings within the administrative region, including residential buildings and office buildings. The address of an interest point is usually located under a road section. The hierarchy of administrative region is the parent hierarchy of road section, and the hierarchy of road section is the child hierarchy of administrative region. The hierarchy of road section is the parent hierarchy of interest point, and the hierarchy of interest point is the child hierarchy of road section.

Take “Ping An Mansion, Bagua Road, Futian District, Shenzhen” as an example, wherein, Futian District is at an administrative district hierarchy, Bagua Road is at a road section hierarchy, and Ping An Mansion is at an interest point hierarchy. Futian District is the parent hierarchy of Bagua Road, and Bagua Road is the child hierarchy of Futian District. Bagua Road is the parent hierarchy of Ping An Mansion and Ping An Mansion is the child hierarchy of Bagua Road. Ping An Mansion does not have a subordinate hierarchy, it can also be called the leaf hierarchy. The leaf hierarchy can be a community, a building, a village or a town. Regions where the population density exceeds the preset density may use a district or a building as the leaf hierarchy, and for regions where the population density is lower than the preset density, a village or a town may be used as the leaf hierarchy.

Step S206, acquiring an insurance policy quantity corresponding to the region name, and a road section quantity corresponding to the region name.

Step S208, performing a verification on the plurality of sub-regions of the administrative region by making use of the insurance policy quantity and the road section quantity.

Step S210, recording the plurality of sub-regions of the administrative region as reasonable sub-regions if the verification is passed.

A city usually includes administrative regions such as a plurality of districts or counties. Each district or county belongs to an independent administrative region. In order to facilitate business personnel to provide services for clients in a relatively concentrated region, insurance companies can arrange business personnel to work in their corresponding administrative regions. Independent administrative regions, such as districts or counties, can serve as the top hierarchy of the hierarchical relationship of administrative region, and the hierarchy of road section is the child hierarchy of an administrative region. When the insurance company arranges business personnel to provide services for clients, the insurance policy quantity is an important reference indicator. When the server performs a verification on the sub-regions of each independent administrative region, the server may verify the division result of sub-regions of a road section hierarchy by taking into consideration of the insurance policy quantity and the road section quantity in the administrative region. If the plurality of sub-regions at the hierarchy of road section are divided reasonably, it means that the division result of the administrative region is suitable for arranging the business personnel to provide services, and the division is reasonable and passes the verification. If there are unreasonable sub-regions in the plurality of sub-regions of the road section, it means that the division result of the administrative region is not suitable for arranging the business personnel to provide services, the division is unreasonable, the verification is not passed, and the unreasonable sub-regions need to be adjusted.

A database is deployed on the server and insurance policy data is stored in the database. The server can perform statistics on the insurance policy quantity for each administrative region in advance. When it is needed to use the insurance policy quantity, the server can acquire the insurance policy quantity of the administrative region based on the region name. If the server did not perform statistics on the insurance policy quantity in advance, the server can acquire the corresponding insurance policy data according to the region name. The insurance policy data includes an insurance policy identification, and the server can perform statistics by making use of the insurance policy identification in the insurance policy data so as to obtain the insurance policy quantity corresponding to the region name.

The database also stores names of all the road sections corresponding to the plurality of administrative regions. The server can acquire a road section name in the administrative regions according to the region name, and count the number of road sections in the administrative region according to the road section name.

The server can calculate to obtain a recommended quantity of sub-regions of the administrative region by making use of the insurance policy quantity corresponding to the region name. The server acquires the quantity of divided sub-regions at road section hierarchy within the administrative region. If the quantity of divided sub-regions falls within the floating range corresponding to the recommended quantity of sub-regions, then the server further compares the recommended quantity of sub-regions or a maximum value of the floating range with the road section quantity. When the recommended quantity of sub-regions is less than or equal to the road section quantity, it indicates that the road section quantity is sufficient to support the division of sub-regions of the road section hierarchy, the sub-regions of the road section within the administrative region are divided reasonably, and the division result of the administrative region passes the verification. Or when the maximum value of the floating range is less than the road section quantity, it means that the road section quantity is sufficient to support the division of sub-regions of the road section hierarchy, the sub-regions within the administrative region are divided reasonably, and the division result of the administrative region passes the verification. The server can record the sub-regions which passed the verification as reasonable sub-regions, that is, the sub-regions are suitable for arranging the business personnel to provide services.

If the quantity of divided sub-regions falls within the floating range corresponding to the recommended quantity of sub-regions, but the maximum value of the floating range corresponding to the recommended quantity of sub-regions is greater than the road section quantity, the verification is not passed. It is necessary to adjust the child hierarchy of the road section hierarchy, for example, to divide the sub-regions, and so on. If the quantity of divided sub-regions does not fall within the floating range corresponding to the recommended quantity of sub-regions, the verification is not passed, and the sub-regions need to be adjusted, for example, to merge one or more sub-regions adjacent to each other. The adjusted division of sub-regions can meet the needs of business personnel by adjusting the sub-regions that have not passed the verification.

In this embodiment, a plurality of divided sub-regions of the administrative region in the electronic map can be acquired by loading the electronic map of the administrative region. A verification is performed on the plurality of sub-regions of the administrative region by making use of the insurance policy quantity and the road section quantity, and the plurality of sub-regions of the administrative region are recorded as reasonable sub-regions if the verification is passed. Thereby, the division result of the administrative region is effectively verified, which in turn ensures that the divided sub-regions are suitable for arranging business personnel to provide services for clients.

In one embodiment, the step of dividing the administrative region into a plurality of sub-regions in the electronic map includes: acquiring insurance policy data, the insurance policy data including a client address therein; identifying the region name of the administrative region corresponding to the client address; searching in the electronic map for a region boundary according to the region name; acquiring a polygon corresponding to a minimum division unit, and dividing the administrative region in the electronic map by making use of the polygon and the region boundary; splicing the plurality of polygons to obtain the plurality of sub-regions.

A database is deployed on the server and insurance policy data is stored in the database. The server calls threads to grab the insurance policy data from the database. The insurance policy data includes insurance policy identification, client identification, and client address, etc. The server can identify the region name corresponding to the administrative region based on the text description in the client address.

The server searches in the electronic map for a region boundary according to the region name; The region boundary includes a plurality of geographic coordinates. The geographic coordinates include longitude and latitude. The geographic coordinates of the region boundary can be stored in the database. The server can be preconfigured with the minimum division unit for dividing the administrative region. The minimum division unit can use a polygon. The polygon refers to a closed graphic composed of three or more lines first and last sequential connected. For example, the polygon may be a triangle or a quadrangle. Preferably, the polygon may take the shape of a quadrangle. The area of the polygon can be set according to the spacing between buildings, and preferably, the area covers a building. For example, the area of the polygon is 20 square meters, which can be regarded as an empirical value. The smaller the area of the polygon, the finer the division of the administrative region by the polygon.

The server divides the administrative region evenly in the electronic map by making use of the polygon and the region boundary, so as to divide the administrative region into a plurality of polygons. For example, the server divides the administrative region into a plurality of quadrangles. If the boundary portion of the administrative region cannot be evenly divided by the polygon, the shape of the boundary portion is preserved. It can be understood that, when the server divides the administrative region by making use of the polygon, there may be a situation that currently there is no client within the area covered by the polygon.

Identify the region name of the administrative region by the client address in the insurance policy data, and search in the electronic map for a region boundary according to the region name. Divide the administrative region in the electronic map by making use of the polygon corresponding to a minimum division unit and the region boundary. The smaller the area of polygon, the finer the division of the administrative region. By splicing the polygons, the plurality of sub-regions are obtained. The division of the administrative region, without manual division, can quickly and effectively complete the division of the administrative region; it not only can effectively improve the efficiency of the division, but also can achieve a fine division of each hierarchy within the administrative region, thereby providing convenience for serving clients.

In one embodiment, the step of performing a verification on the plurality of sub-regions of the administrative region by making use of the insurance policy quantity and the road section quantity includes: calculating to obtain a recommended quantity of sub-regions corresponding to the administrative region by making use of the insurance policy quantity corresponding to the region name; acquiring a quantity of divided sub-regions of the administrative region from the electronic map; judging whether the recommended quantity of sub-regions falls within a floating range corresponding to the recommended quantity of sub-regions; if yes, further comparing a maximum value of the floating range with the road section quantity; if the maximum value of the floating range is less than the road section quantity, the verification is passed.

The server acquires a recommended quantity of insurance policy corresponding to the sub-regions at road section hierarchy, and calculating to obtain a recommended quantity of sub-regions at road section hierarchy corresponding to the administrative region by making use of the recommended quantity of insurance policy at road section hierarchy corresponding to the region name. Specifically, the recommended quantity of sub-regions at road section hierarchy may be the quotient (which may be an integer) between the insurance policy quantity corresponding to the region name and the recommended quantity of insurance policy corresponding to the sub-regions at road section hierarchy. For example, if the insurance policy quantity corresponding to the region name is 10,000, and the recommended quantity of insurance policy corresponding to the sub-regions at road section hierarchy is 500, then the recommended quantity of sub-regions at road section hierarchy is 20. The recommended quantity of insurance policy corresponding to the sub-regions at road section hierarchy can be adjusted according to the status of insurance business.

Considering that there will be some changes in the insurance policy quantity over time, in order to allow the division result of the administrative region to be applicable to the arrangements of business personnel in the next few years (such as in the next 3-5 years), when the server performs a verification on the sub-regions of road section hierarchy, a floating range can be calculated based on the recommended quantity of sub-regions. Specifically, the server can calculate to obtain the floating range corresponding to the recommended quantity of sub-regions according to the floating ratio and the recommended quantity of sub-regions. For example, if the floating ratio is 10%, the server can calculate to obtain the quantity corresponding to the quantity of sub-regions to be upwardly floated by 10%, and the quantity corresponding to the quantity of sub-regions to be downwardly floated by of 10%. The server generates a corresponding floating range based on the calculated floating ratio. The server acquires a quantity of divided sub-regions of the administrative region from the electronic map, and judges whether the recommended quantity of sub-regions falls within a floating range corresponding to the recommended quantity of sub-regions. If the recommended quantity of sub-regions falls within a floating range corresponding to the recommended quantity of sub-regions, the server needs to further verify the division result of the administrative region based on the road section quantity within the administrative region.

The maximum value in the floating range corresponding to the recommended quantity of sub-regions may be referred to as the maximum value of the recommended quantity of sub-regions. The server compares the maximum value of the recommended quantity of sub-regions with the road section quantity. If the maximum value of the recommended quantity of sub-regions is less than or equal to the road section quantity, it means that the road section quantity in the administrative region is sufficient for dividing the sub-regions according to the road section. In other words, this division result indicates that each road section may have a corresponding sub-region, or that there are two or more road sections corresponding to one sub-region. For example, the road section quantity in Futian District is 20, and the maximum value of the recommended quantity of sub-regions is 15. The divided sub-regions in the electronic map may be a sub-region corresponding to one road section, or may be a sub-region corresponding to two or more road sections. When the division result of the administrative region passes the verification, the server records the plurality of sub-regions of the administrative region as reasonable sub-regions, that is, sub-regions suitable for arranging business personnel to provide services.

If the quantity of divided sub-regions falls within the floating range corresponding to the recommended quantity of sub-regions, but the maximum value of the recommended quantity of sub-regions is greater than the road section quantity, it indicates that the road section quantity in the administrative region is not sufficient for dividing the sub-regions by the road section. If the quantity of divided sub-regions does not fall within the floating range corresponding to the maximum value of the recommended quantity of sub-regions, it indicates that the quantity of divided sub-regions is not reasonable, and the verification is not passed.

In this embodiment, calculate to obtain the floating range corresponding to the recommended quantity of sub-regions by making use of the insurance policy quantity, and perform a verification on the division of sub-regions in the administrative region by making use of the floating range and the road section quantity, the division result is not only verified by the actual insurance service status, but also by the changes in the future insurance policy quantity, thus ensuring an effective verification of the division result of the administrative region.

In one embodiment, the method further includes: if the verification is not passed, scan a plurality of road sections corresponding to the administrative region, to acquire the interest points corresponding to the road sections; adjust the sub-regions of the administrative region according to the interest points.

In this embodiment, if the division result of the administrative region at the road section hierarchy does not pass the verification, the sub-regions at the road section hierarchy need to be adjusted. The server can scan the plurality of road sections corresponding to the administrative region and acquire the interest points corresponding to the road section. The interest points can be buildings such as communities or buildings. There may be one or more clients at the interest points. The interest point name can be included in the client address. The server can adjust the sub-regions of the administrative region according to the interest points.

The server can search among the client addresses by making use of the interest point name, so as to acquire the client address containing the interest point name. Acquire the insurance policy identification according to the client address including the interest point name, so as to obtain the insurance policy identification corresponding to the interest point. The server counts the number of the insurance policy identification corresponding to the interest points to obtain the insurance policy quantity corresponding to the interest points. The server calculates to obtain an adjusted quantity of sub-regions based on the recommended quantity of sub-regions and the quantity of divided sub-regions. When the recommended quantity of sub-regions is greater than the quantity of divided sub-regions, one or more sub-regions need to be split. The adjusted quantity of sub-regions is namely the number of the sub-region to be split. For example, the road section quantity in Futian District is 15, and the maximum value of the recommended quantity of sub-regions is 20. It is necessary to divide the sub-regions at one or more of the road section hierarchies so that the quantity of sub-regions can reach 20.

In one embodiment, the step of adjusting the sub-regions of the administrative region according to the interest points includes: acquiring the insurance policy quantity corresponding to a plurality of interest points; extracting one or more interest points from the interest points according to the recommended quantity of sub-regions as regions to be split; performing a split on the regions to be split according to the insurance policy quantity corresponding to the region to be split and the recommended quantity of the insurance policies corresponding to the sub-regions.

When there is a large difference in the insurance policy quantity between different interest points, the server can sort the insurance policy quantities corresponding to the plurality of interest points, for example, to sort the insurance policy quantities from most to least. The server extracts one or more interest points as the regions to be split, according to the quantity of divided sub-regions, and according to the order of the insurance policy quantities from most to least. The server performs a split on the regions to be split. The server can perform a split on the regions to be split in order to balance the insurance policy quantities corresponding to the regions split as much as possible. For example, if the insurance policy quantity in the region to be split is greater than 3 times of the recommended quantity of insurance policy corresponding to the sub-regions, the region to be split may be split into 3 sub-regions. If the insurance policy quantity in the region to be split is greater than 2 times of the recommended quantity of policy corresponding to the sub-regions, the region to be split can be split into 2 sub-regions. Therefore, when there is a large difference in the insurance policy quantity between different interest points, split can be performed according to the interest points, so that the insurance policy quantity between the split sub-regions can be relatively balanced, which is conducive to arranging business personnel to follow-up the services.

In one embodiment, the sub-regions include an unplanned region, the step of adjusting the sub-regions of the administrative region according to the interest points includes: acquiring the interest points in the unplanned region; extracting one or more interest points from the interest points in the unplanned region, based on the recommended quantity of sub-regions; performing a split on the unplanned region according to the interest points extracted.

When the insurance policy quantity between different interest points is relatively balanced, the server can acquire the unplanned region from the sub-regions. The sub-regions include planned regions and unplanned regions, wherein, the planned regions refer to the regions that currently have clients, and the planned regions have the insurance policy quantity. The unplanned regions refer to the regions where there are no clients, the insurance policy quantity corresponding to the unplanned regions is currently 0. Considering that insurance companies need to develop clients in the unplanned regions, the server can perform a split on one or more unplanned regions. Specifically, the server acquires one or more interest points from a plurality of unplanned regions. The server calculates to obtain the quantity of divided sub-regions based on the recommended quantity of sub-regions and the quantity of divided sub-regions. The server extracts one or more interest points based on the recommended quantity of sub-regions, and performs a split on the unplanned region according to the interest points extracted. For example, the server may sort the areas of the plurality of interest points in the unplanned regions. The larger the area of the interest point, the larger the population it covers and the greater the number of potential clients. The server can extract one or more interest points as the region to be split according to the area from big to small. Therefore, when the insurance policy quantity between different interest points within the planned regions is roughly equivalent, the use of the interest points to separate the unplanned regions can facilitate the subsequent arrangement of business personnel to carry out the client development.

When the recommended quantity of sub-regions is smaller than the quantity of divided sub-regions, one or more sub-regions need to be merged, and the adjusted quantity of sub-regions is namely the quantity of the merged sub-regions. When the sub-regions need to be merged, the server can sort the insurance policy quantities corresponding to the plurality of interest points. The server extracts one or more sub-regions in ascending order according to the quantity of the merged sub-regions, and the server compares the extracted sub-regions with their neighboring sub-regions so as to obtain a sub-region having the minimum insurance policy quantity, and the extracted sub-regions are merged with their corresponding neighboring sub-regions having the minimum insurance policy quantity.

Further, when the division result of the administrative region fails to pass the verification, the sub-regions at the road section hierarchy can be adjusted by a terminal. After the server verifies the division result of the administrative region in the electronic map in the manner as in the foregoing embodiment, if the verification is not passed, the server may generate prompt information. The server can also send the prompt information indicating that the verification is not passed, to the terminal corresponding to the manager. Thereby allowing the manager to adjust the failed sub-regions through the terminal manually.

In one embodiment, the method further includes: receiving, from a terminal, a request of acquiring the electronic map of the administrative region; sending the electronic map of the administrative region to the terminal according to the request, the electronic map including a plurality of sub-regions corresponding to the administrative region that have not passed the verification, to enable the terminal to adjust the sub-regions in the electronic map; receiving an adjusted electronic map returned by the terminal.

The server stores the division result of each hierarchy in the database. Through the terminal, the manager may send a request of acquiring the hierarchically divided electronic map to the server, the server acquires the hierarchically divided electronic map from the database according to the request, and sends the electronic map to the terminal for displaying at the terminal. When the verification of the sub-regions at road section hierarchy corresponding to the administrative region is not passed, the server records the sub-regions at road section hierarchy as unreasonable sub-regions.

In order to make each business personnel's workload as equivalent as possible, when the insurance companies assign business personnel to provide services for clients, they usually take into consideration of the insurance policy quantity in each sub-region. The server can identify currently existing clients in the sub-regions. Specifically, the server marks the polygon of the minimum division unit according to the geographic coordinates of the client address, for example, to add colors to the polygon, and marks all the existing clients in the sub-regions. This allows the manager to see the status of clients in each sub-region visually. For example, the darker the color is, the bigger the insurance policy quantity is, the lighter the color is, the smaller the insurance policy quantity is. If the sub-region has a small insurance policy quantity, the workload of the business personnel will be insufficient. If the sub-region has a large insurance policy quantity, the workload of the business personnel will be over saturated.

In order to make a balanced distribution of the workload of the business personnel, the manager can adjust the sub-regions in the electronic map through the terminal. The server compares the insurance policy quantity in each sub-region with the first threshold and the second threshold, respectively, if the insurance policy quantity exceeds the first threshold, it means that the insurance policy quantity in the sub-region is too big, which will make the workload of the business personnel over saturated, the sub-region needs to be adjusted. If the insurance policy quantity is lower than the second threshold, it means that the insurance policy quantity in the sub-regions is too small, which will make the workload of the business personnel insufficient, and the sub-region needs to be adjusted.

The adjustment includes split and merger of the sub-regions. An application program is installed on the terminal, and the sub-regions in the electronic map can be divided or combined through the application program, wherein, the menu of the application program can be a multi-level menu. When the cursor is located in the menu control of the first level, a multi-level menu can be displayed on the screen, thereby providing convenience for the manager to select the desired menu control.

The terminal sends a request of acquiring the electronic map to the server according to the adjustment prompt, and the server sends the electronic map which is divided into a plurality of sub-regions to the terminal for displaying at the terminal. For the sub-regions that need to be adjusted, hints can be made by means of the color of the sub-regions or the blinking of the region boundary in the sub-regions. The manager can adjust the sub-regions in the electronic map through the terminal. The adjustment includes split and merger of the sub-regions. For the sub-regions where the insurance policy quantity exceeds the first threshold, the manager will divide the sub-regions. For the sub-regions where the insurance policy quantity is smaller than the second threshold, the manager will merge the sub-regions with their neighboring sub-regions.

When the sub-regions need to be divided, the manager can refer to the color marks in the sub-regions, and select the sub-regions to be divided from the electronic map through the terminal, so as to generate a plurality of edit points on the boundary of the sub-regions to be divided. The manager creates a split starting point by selecting an edit point from the terminal, and selects another edit point to generate a split end point. The terminal draws a dividing line in the sub-regions according to the path between the dividing start point and the dividing end point. The divided sub-regions are generated by making use of dividing lines and the boundary of sub-regions, so that a sub-region is divided.

When the sub-regions need to be merged, the manager can refer to the color marks in the sub-regions, select the sub-regions to be merged from the electronic map through the terminal, and the sub-regions to be merged are two or more adjacent sub-regions. The terminal receives the merge instruction input by the manager, and merges the sub-regions to be merged according to the merge instruction.

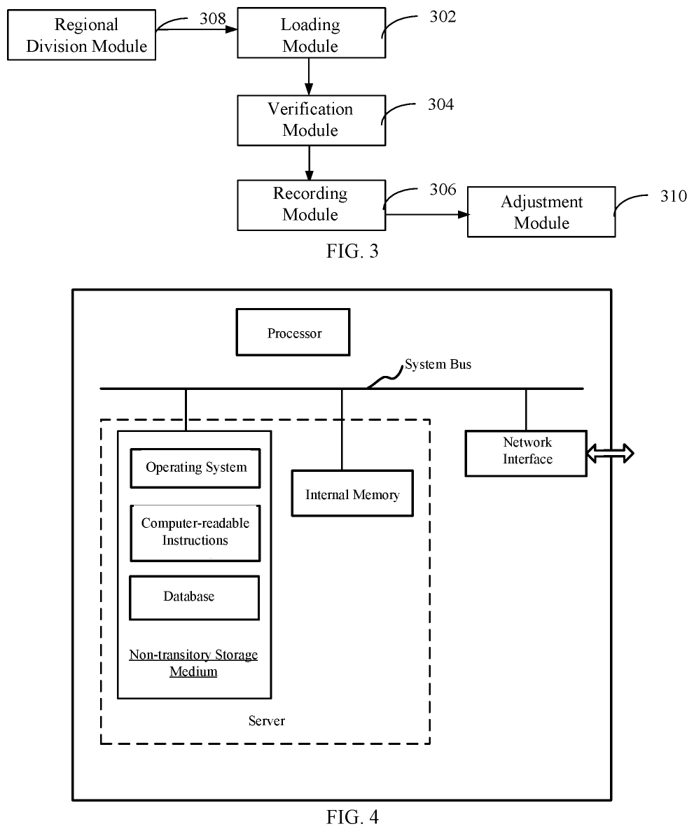

In one embodiment, a device for division of an administrative region is provided. As shown in FIG. 3, the device includes a loading module 302, a verification module 304, and a recording module 306.

Wherein, the loading module 302 is configured to acquire a region name of an administrative region; to load an electronic map corresponding to the administrative region according to the region name, the administrative region being divided into a plurality of sub-regions in the electronic map.

The verification module 304 is configured to acquire an insurance policy quantity corresponding to the region name, and a road section quantity corresponding to the region name; to perform a verification on the plurality of sub-regions of the administrative region by making use of the insurance policy quantity and the road section quantity.

The recording module 306 is configured to record the plurality of sub-regions of the administrative region as reasonable sub-regions if the verification is passed.

In one embodiment, the device further includes a region division module 308, which is configured to acquire insurance policy data, the insurance policy data including a client address therein; to identify the region name of the administrative region corresponding to the client address; to search in the electronic map for a region boundary according to the region name; to acquire a polygon corresponding to a minimum division unit, to divide the administrative region in the electronic map by making use of the polygon and the region boundary; and to splice the plurality of polygons to obtain the plurality of sub-regions.

In one embodiment, the verification module 304 is also configured to calculate to obtain a recommended quantity of sub-regions corresponding to the administrative region by making use of the insurance policy quantity corresponding to the region name; to acquire a quantity of divided sub-regions of the administrative region from the electronic map; to judge whether the recommended quantity of sub-regions falls within a floating range corresponding to the recommended quantity of sub-regions; and if yes, further to compare a maximum value of the floating range with the road section quantity; if the maximum value of the floating range is less than the road section quantity, the verification is passed.

In one embodiment, the device further includes an adjustment module 310, which is configured to, if the verification is not passed, scan a plurality of road section corresponding to the administrative region, to acquire interest points corresponding to the road section; to adjust the sub-regions of the administrative region according to the interest points.

In one embodiment, the adjustment module 310 is also configured to acquire the insurance policy quantity corresponding to a plurality of interest points; to extract one or more interest points from the interest points according to the recommended quantity of sub-regions as regions to be split; to perform a split on the regions to be split according to the insurance policy quantity corresponding to the region to be split and the recommended quantity of the insurance policies corresponding to the sub-regions.

In one embodiment, the adjustment module 310 is also configured to acquire the interest points in the unplanned region; to extract one or more interest points from the interest points in the unplanned region, based on the recommended quantity of sub-regions; to perform a split on the unplanned region according to the interest points extracted.

In one embodiment, the device further includes a communication module 312, which is configured to receive, from a terminal, a request of acquiring the electronic map of the administrative region; to send the electronic map of the administrative region to the terminal according to the request, the electronic map including a plurality of sub-regions corresponding to the administrative region that have not passed the verification, to enable the terminal to adjust the sub-regions in the electronic map; to receive an adjusted electronic map returned by the terminal.

In one embodiment, a server is provided, as shown in FIG. 4, the server includes a processor, a memory and a network interface which are connected via a system bus. Wherein, the processor of the server is configured to provide computation and control capabilities. The memory of the server further includes a non-transitory storage medium and an internal memory. The non-transitory storage medium of the server stores an operating system, computer-readable instructions and a database, a verification method for division of an administrative region is implemented when the computer-readable instructions are executed by the processor. The database stores insurance policy data and division result of an administrative region. The internal memory of the server provides an operating environment for the operation system and the computer-readable instructions in the non-transitory storage medium. The network interface of the server is configured to communicate with the external terminal over a network, for example, receiving, from a terminal, a request of acquiring the electronic map of the administrative region. Persons skilled in the art can understand that, the structure shown in FIG. 4 is only a part of the structure of the solution of the present disclosure, which does not impose limitation to the server to which the present disclosure applies, specifically, the server can include more or less components than those shown in the drawing, or can combine some components, or can have different component deployments.

A server includes a memory and one or more processors, the memory having computer-readable instructions stored thereon, following steps are implemented when the computer-readable instructions are executed by the one or more processors:

acquiring a region name of an administrative region;

loading an electronic map corresponding to the administrative region according to the region name, the administrative region being divided into a plurality of sub-regions in the electronic map;

acquiring an insurance policy quantity corresponding to the region name, and a road section quantity corresponding to the region name;

performing a verification on the plurality of sub-regions of the administrative region by making use of the insurance policy quantity and the road section quantity; and

recording the plurality of sub-regions of the administrative region as reasonable sub-regions if the verification is passed.

In one embodiment, following steps are implemented when the computer-readable instructions are executed by the one or more processors:

acquiring insurance policy data, the insurance policy data including a client address therein;

identifying the region name of the administrative region corresponding to the client address;

searching in the electronic map for a region boundary according to the region name;

acquiring a polygon corresponding to a minimum division unit, and dividing the administrative region in the electronic map by making use of the polygon and the region boundary; and

splicing the plurality of polygons to obtain the plurality of sub-regions.

In one embodiment, following steps are implemented when the computer-readable instructions are executed by the one or more processors:

calculating to obtain a recommended quantity of sub-regions corresponding to the administrative region by making use of the insurance policy quantity corresponding to the region name;

acquiring a quantity of divided sub-regions of the administrative region from the electronic map;

judging whether the recommended quantity of sub-regions falls within a floating range corresponding to the recommended quantity of sub-regions; and

if yes, further comparing a maximum value of the floating range with the road section quantity; if the maximum value of the floating range is less than the road section quantity, the verification is passed.

In one embodiment, following steps are implemented when the computer-readable instructions are executed by the one or more processors:

if the verification is not passed, scanning a plurality of road sections corresponding to the administrative region, to acquire interest points corresponding to the road section; and

adjusting the sub-regions of the administrative region according to the interest points.

In one embodiment, following steps are implemented when the computer-readable instructions are executed by the one or more processors:

acquiring the insurance policy quantity corresponding to a plurality of interest points;

extracting one or more interest points from the interest points according to the recommended quantity of sub-regions as regions to be split; and

performing a split on the regions to be split according to the insurance policy quantity corresponding to the region to be split and the recommended quantity of the insurance policies corresponding to the sub-regions.

In one embodiment, following steps are implemented when the computer-readable instructions are executed by the one or more processors:

acquiring the insurance policy quantity according to the plurality of interest points;

extracting one or more interest points as a region to be split, according to the recommended quantity of sub-regions; and

performing a split on the region to be split according to the insurance policy quantity corresponding to the region to be split, and according to a recommended quantity of insurance policies corresponding to the sub-regions.

In one embodiment, following steps are implemented when the computer-readable instructions are executed by the one or more processors:

acquiring the interest points in the unplanned region;

extracting one or more interest points from the interest points in the unplanned region, based on the recommended quantity of sub-regions; and

performing a split on the unplanned region according to the interest points extracted.

In one embodiment, following steps are implemented when the computer-readable instructions are executed by the one or more processors:

receiving, from a terminal, a request of acquiring the electronic map of the administrative region;

sending the electronic map of the administrative region to the terminal according to the request, the electronic map including a plurality of sub-regions corresponding to the administrative region that have not passed the verification, to enable the terminal to adjust the sub-regions in the electronic map; and

receiving an adjusted electronic map returned by the terminal.

In one embodiment, one or more non-transitory computer-readable storage mediums having computer-readable instructions stored thereon are provided, following steps are implemented when the computer-readable instructions are executed by the one or more processors:

acquiring a region name of an administrative region;

loading an electronic map corresponding to the administrative region according to the region name, the administrative region being divided into a plurality of sub-regions in the electronic map;

acquiring an insurance policy quantity corresponding to the region name, and a road section quantity corresponding to the region name;

performing a verification on the plurality of sub-regions of the administrative region by making use of the insurance policy quantity and the road section quantity; and

recording the plurality of sub-regions of the administrative region as reasonable sub-regions if the verification is passed.

In one embodiment, following steps are implemented when the computer-readable instructions are executed by the one or more processors:

acquiring insurance policy data, the insurance policy data including a client address therein;

identifying the region name of the administrative region corresponding to the client address;

searching in the electronic map for a region boundary according to the region name;

acquiring a polygon corresponding to a minimum division unit, and dividing the administrative region in the electronic map by making use of the polygon and the region boundary; and

splicing the plurality of polygons to obtain the plurality of sub-regions.

In one embodiment, following steps are implemented when the computer-readable instructions are executed by the one or more processors:

calculating to obtain a recommended quantity of sub-regions corresponding to the administrative region by making use of the insurance policy quantity corresponding to the region name;

acquiring a quantity of divided sub-regions of the administrative region from the electronic map;

judging whether the recommended quantity of sub-regions falls within a floating range corresponding to the recommended quantity of sub-regions; and

if yes, further comparing a maximum value of the floating range with the road section quantity; if the maximum value of the floating range is less than the road section quantity, the verification is passed.

In some embodiments, following steps are implemented when the computer-readable instructions are executed by the one or more processors:

if the verification is not passed, scanning plurality of road section corresponding to the administrative region, to acquire the interest points corresponding to the road section; and

adjusting the sub-regions of the administrative region according to the interest points.

In some embodiments, following steps are implemented when the computer-readable instructions are executed by the one or more processors:

acquiring the insurance policy quantity corresponding to a plurality of interest points;

extracting one or more interest points from the interest points according to the recommended quantity of sub-regions as regions to be split; and

performing a split on the regions to be split according to the insurance policy quantity corresponding to the region to be split and the recommended quantity of the insurance policies corresponding to the sub-regions.

In some embodiments, following steps are implemented when the computer-readable instructions are executed by the one or more processors:

acquiring the interest points in the unplanned region;

extracting one or more interest points from the interest points in the unplanned region, based on the recommended quantity of sub-regions; and

performing a split on the unplanned region according to the interest points extracted.

In some embodiments, following steps are implemented when the computer-readable instructions are executed by the one or more processors:

receiving, from a terminal, a request of acquiring the electronic map of the administrative region;

sending the electronic map of the administrative region to the terminal according to the request, the electronic map including a plurality of sub-regions corresponding to the administrative region that have not passed the verification, to enable the terminal to adjust the sub-regions in the electronic map; and receiving an adjusted electronic map returned by the terminal.

A person skilled in the art should understand that the processes of the methods in the above embodiments can be, in full or in part, implemented by computer-readable instructions through instructing relevant hardware. The computer-readable instructions can be stored in a computer-readable storage medium, the processes in the embodiments of the various methods can be implemented when the computer-readable instructions are executed. Wherein, the storage medium can include a disk, CD an read only memory (ROM), etc.

Various technical features of the foregoing embodiments may be combined in any combination. For the sake of brevity of description, not all possible combinations of the various technical features of the foregoing embodiments are described. However, as long as there is no contradiction between the combinations of the technical features, all should be considered within the scope of the disclosure of the description.

The above-mentioned embodiments are merely illustrative of several implementations of the present application, and the description thereof is more specific and detailed, but is not to be construed as limiting the scope of the invention. It should be noted that, a number of variations and improvements may be made by those skilled in the art without departing from the conception of the present application, and shall all fall into the protection scope of the present invention. Therefore, the protection scope of the present invention shall be defined by the appended claims.

1. A verification method for division of an administrative region, comprising steps of:
acquiring a region name of an administrative region;
loading an electronic map corresponding to the administrative region according to the region name, the administrative region being divided into a plurality of sub-regions in the electronic map;
acquiring an insurance policy quantity corresponding to the region name, and a road section quantity corresponding to the region name;
performing a verification on the plurality of sub-regions of the administrative region by making use of the insurance policy quantity and the road section quantity; and
recording the plurality of sub-regions of the administrative region as reasonable sub-regions if the verification is passed.

2. The method of claim 1, further comprising:
acquiring insurance policy data, the insurance policy data including a client address therein;
identifying the region name of the administrative region corresponding to the client address;
searching in the electronic map for a region boundary according to the region name;
acquiring a polygon corresponding to a minimum division unit, and dividing the administrative region in the electronic map by making use of the polygon and the region boundary, so as to obtain a plurality of polygons corresponding to the administrative region; and
splicing the plurality of polygons corresponding to the administrative region, so as to obtain the plurality of sub-regions.

3. The method of claim 1, wherein, the step of performing a verification on the plurality of sub-regions of the administrative region by making use of the insurance policy quantity and the road section quantity comprises:
calculating to obtain a recommended quantity of sub-regions corresponding to the administrative region by making use of the insurance policy quantity corresponding to the region name;
acquiring a quantity of divided sub-regions of the administrative region from the electronic map;
judging whether the recommended quantity of sub-regions falls within a floating range corresponding to the recommended quantity of sub-regions; and
if the recommended quantity of sub-regions falls within a floating range corresponding to the recommended quantity of sub-regions, further comparing a maximum value of the floating range with the road section quantity; if the maximum value of the floating range is less than the road section quantity, the verification is passed.

4. The method of claim 1, further comprising:
if the verification is not passed, scanning a plurality of road sections corresponding to the administrative region, to acquire interest points corresponding to the road sections; and
adjusting the sub-regions of the administrative region according to the interest points.

5. The method of claim 4, wherein, the step of adjusting the sub-regions of the administrative region according to the interest point comprises:
acquiring the insurance policy quantity corresponding to a plurality of interest points;
extracting one or more interest points from the interest points according to the recommended quantity of sub-regions as regions to be split; and
performing a split on the regions to be split according to the insurance policy quantity corresponding to the region to be split and the recommended quantity of the insurance policies corresponding to the sub-regions.

6. The method of claim 4, wherein, the sub-regions comprise an unplanned region, the step of adjusting the sub-regions of the administrative region according to the interest points comprises:
acquiring the interest points in the unplanned region;
extracting one or more interest points from the interest points in the unplanned region, based on the recommended quantity of sub-regions; and
performing a split on the unplanned region according to the interest points extracted.

7. The method of claim 1, further comprising:
receiving, from a terminal, a request of acquiring the electronic map of the administrative region;
sending the electronic map of the administrative region to the terminal according to the request, the electronic map including a plurality of sub-regions corresponding to the administrative region that have not passed the verification, to enable the terminal to adjust the sub-regions in the electronic map; and
receiving an adjusted electronic map returned by the terminal.

8.-10. (canceled)

11. A server, comprising a memory and one or more processors, the memory having computer-readable instructions stored thereon, following steps are implemented when the computer-readable instructions are executed by the one or more processors:
acquiring a region name of an administrative region;
loading an electronic map corresponding to the administrative region according to the region name, the administrative region being divided into a plurality of sub-regions in the electronic map;
acquiring an insurance policy quantity corresponding to the region name, and a road section quantity corresponding to the region name;
performing a verification on the plurality of sub-regions of the administrative region by making use of the insurance policy quantity and the road section quantity; and
recording the plurality of sub-regions of the administrative region as reasonable sub-regions if the verification is passed.

12. The server of claim 11, wherein, following steps are implemented when the computer-readable instructions are executed by the one or more processors:
acquiring insurance policy data, the insurance policy data including a client address therein;
identifying the region name of the administrative region corresponding to the client address;
searching in the electronic map for a region boundary according to the region name;
acquiring a polygon corresponding to a minimum division unit, and dividing the administrative region in the electronic map by making use of the polygon and the region boundary, so as to obtain a plurality of polygons corresponding to the administrative region; and
splicing the plurality of polygons corresponding to the administrative region, so as to obtain the plurality of sub-regions.

13. The server of claim 11, wherein, following steps are implemented when the computer-readable instructions are executed by the one or more processors:
calculating to obtain a recommended quantity of sub-regions corresponding to the administrative region by making use of the insurance policy quantity corresponding to the region name;
acquiring a quantity of divided sub-regions of the administrative region from the electronic map;
judging whether the recommended quantity of sub-regions falls within a floating range corresponding to the recommended quantity of sub-regions; and
if the recommended quantity of sub-regions falls within a floating range corresponding to the recommended quantity of sub-regions, further comparing a maximum value of the floating range with the road section quantity; if the maximum value of the floating range is less than the road section quantity, the verification is passed.

14. The server of claim 11, wherein, following steps are implemented when the computer-readable instructions are executed by the one or more processors:
if the verification is not passed, scanning a plurality of road sections corresponding to the administrative region, to acquire interest points corresponding to the road sections; and
adjusting the sub-regions of the administrative region according to the interest points.

15. The server of claim 14, wherein, following steps are implemented when the computer-readable instructions are executed by the one or more processors:
acquiring the insurance policy quantity corresponding to a plurality of interest points;
extracting one or more interest points from the interest points according to the recommended quantity of sub-regions as regions to be split; and
performing a split on the regions to be split according to the insurance policy quantity corresponding to the region to be split and the recommended quantity of the insurance policies corresponding to the sub-regions.

16. One or more non-transitory computer-readable storage medium comprising computer-readable instructions, following steps are implemented when the computer-readable instructions are executed by the one or more processors:
acquiring a region name of an administrative region;
loading an electronic map corresponding to the administrative region according to the region name, the administrative region being divided into a plurality of sub-regions in the electronic map;
acquiring an insurance policy quantity corresponding to the region name, and a road section quantity corresponding to the region name;
performing a verification on the plurality of sub-regions of the administrative region by making use of the insurance policy quantity and the road section quantity; and
recording the plurality of sub-regions of the administrative region as reasonable sub-regions if the verification is passed.

17. The storage medium of claim 16, wherein, following steps are implemented when the computer-readable instructions are executed by the one or more processors:
acquiring insurance policy data, the insurance policy data including a client address therein;
identifying the region name of the administrative region corresponding to the client address;
searching in the electronic map for a region boundary according to the region name;
acquiring a polygon corresponding to a minimum division unit, and dividing the administrative region in the electronic map by making use of the polygon and the region boundary, so as to obtain a plurality of polygons corresponding to the administrative region; and
splicing the plurality of polygons corresponding to the administrative region, so as to obtain the plurality of sub-regions.

18. The storage medium of claim 16, wherein, following steps are implemented when the computer-readable instructions are executed by the one or more processors:
calculating to obtain a recommended quantity of sub-regions corresponding to the administrative region by making use of the insurance policy quantity corresponding to the region name;
acquiring a quantity of divided sub-regions of the administrative region from the electronic map;
judging whether the recommended quantity of sub-regions falls within a floating range corresponding to the recommended quantity of sub-regions; and
if the recommended quantity of sub-regions falls within a floating range corresponding to the recommended quantity of sub-regions, further comparing a maximum value of the floating range with the road section quantity; if the maximum value of the floating range is less than the road section quantity, the verification is passed.

19. The storage medium of claim 16, wherein characterized in that, following steps are implemented when the computer-readable instructions are executed by the one or more processors:
if the verification is not passed, scanning a plurality of road sections corresponding to the administrative region, to acquire the interest points corresponding to the road sections; and
adjusting the sub-regions of the administrative region according to the interest points.

20. The storage medium of claim 19, wherein, following steps are implemented when the computer-readable instructions are executed by the one or more processors:
acquiring the insurance policy quantity corresponding to a plurality of interest points;
extracting one or more interest points from the interest points according to the recommended quantity of sub-regions as regions to be split; and
performing a split on the regions to be split according to the insurance policy quantity corresponding to the region to be split and the recommended quantity of the insurance policies corresponding to the sub-regions.
